(19) United States
(12) Patent Application Publication
(10) Pub. No.: US 2018/0043951 A1
(43) Pub. Date: Feb. 15, 2018

(54) MECANUM WHEELED VEHICLE

(71) Applicant: OMNIROLL AG, Bellach (CH)

(72) Inventors: Baudouin Uebelhart, Oberdorf (CH); Pavel Zdrahal, Pfäffikon (CH)

(21) Appl. No.: 15/536,687

(22) PCT Filed: Dec. 2, 2015
(86) PCT No.: PCT/EP2015/078402

§ 371 Date: Oct. 25, 2017

(30) Foreign Application Priority Data
Dec. 16, 2014 (EP) 14198363.5

(51) Int. Cl. B62D 61/12; B60B 19/12; B66F 9/075; B62D 59/04; B60G 17/02; B60G 11/23

(52) U.S. Cl. CPC B62D 61/12; B60G 17/02; B60G 11/23; B66F 9/07572; B62D 59/04; B60B 19/12

(57) ABSTRACT

Mecanum wheeled vehicle for transporting a payload, having multiple, mecanum wheel drives (2), in each case including at least one mecanum wheel and at least one electromotive, drive, having control means (13) configured for controlling the mecanum wheel drives (2) for an omnidirectional operation, having a chassis (6), the weight force of which can be supported on a base (U) via the mecanum wheels (3) as well as via support means (6) of the vehicle provided additionally to the mecanum wheels (3), wherein the mecanum wheels (3), together with the assigned drives, are mounted resiliently relative to the chassis using force storage means (4) for limiting the weight force proportion of the chassis (5) to be supported via the mecanum wheels (3) on the base (U) and a possible payload (10) to be carried by the chassis.

### BACKGROUND OF THE INVENTION

The invention relates to a mecanum wheeled vehicle for omnidirectional driving maneuvers, in particular without mechanical steering mechanism as disclosed herein. Further, the invention relates to a system as well as to a method for operating a mecanum wheeled vehicle, also as disclosed herein.

Mecanum wheeled vehicles are generally known. In a mecanum wheel, multiple rotatably mounted rolls, generally barrel-shaped, are attached rotatably at an angle to the rotational axis of the rim, of mostly 45° over the circumference of a rim of the wheel. Not the rim, but exclusively the above-mentioned rolls make contact to the base. Here, the rolls do not have any direct drive and can freely rotate around their respective roll rotational axis (which extends at an angle to the rotational axis of the rim or the mecanum wheel). In contrast, the entire mecanum wheel can be driven by a drive, usually an electric motor having a changeable rotational direction and variable rotational speed. Known mecanum wheeled vehicles usually have four wheels, which are arranged in a rectangle. A corresponding control of the drives of the mecanum wheels allows an overall movement direction for the vehicle to be adjusted by individually selecting the rotational direction of the mecanum wheels relative to the base (road) from the sum of vectors of the individual mecanum wheels, wherein any vehicle movement directions, i.e. an omnidirectional operation, is realized. The basic principle of the mecanum wheel is described in DE 2 153 019 A, for example.

Compared to known mecanum wheels, an improved mecanum wheel is described in WO 2013/041310 A1, which is characterized in that two rims of the mecanum wheel carrying in each case rotatable rolls are connected to one another via damping means which allow an absorbed or damped relative movement of the rims to one another, thereby avoiding uncontrolled poises of former mecanum wheeled vehicles, which resulted from a change of a support point travelling along the rolls from roll to roll upon rotation of the rim.

Mecanum wheeled vehicles for an omnidirectional operation, in particular having the above-mentioned improved mecanum wheels have proven of value. Due to the comparably complex structure of mecanum wheels compared to common roll motion wheels, the maximum load capacity of mecanum wheels is subjected to narrow limits whereby mecanum wheeled vehicles to date are only of limited suitability for carrying loads (payloads) or for driving particularly heavy vehicles.

### SUMMARY OF THE INVENTION

Based upon the above-mentioned prior art, the object underlying the invention is to provide a mecanum wheeled vehicle improved with respect to the load bearing performance thereof, with which an omnidirectional operation is possible despite a high vehicle weight and/or high payload. Furthermore, the object is to provide a system comprising an improved mecanum wheeled vehicle as well as a load carried by this vehicle. Furthermore, the object is to provide an operating method for advantageously operating an improved mecanum wheeled vehicle.

Regarding the mecanum wheeled vehicle, this object is achieved by the features disclosed herein.

Regarding the system, and regarding the method, these objects are also achieved with the features disclosed herein.

Advantageous developments of the invention are indicated in the dependent claims. All combinations of at least two of the features disclosed in the description, the claims and/or the figures are in the scope of the invention.

The mecanum wheeled vehicle configured according to the concept of the invention comprises multiple, in particular three or four mecanum wheel drives, wherein the mecanum wheels are preferably arranged so as to limit the edges of a virtual triangle or rectangle. In particular in the case that comparably high payloads must be transported and/or the total weight of the mecanum wheeled vehicle is comparably high, resulting in that large roll-off resistances need be overcome, it is conceivable to provide more than three or four mecanum wheel drives, each including a mecanum wheel and a, in particular electromotive, drive, wherein it is preferred that the more than three or four mecanum wheel drives are in turn combined into three or four groups, which are controllable in groups by the control means to ensure optimized control. Basically, it is also conceivable to assign one of the mecanum wheels or multiple of the mecanum wheels, preferably all mecanum wheels with multiple drives, in particular one drive on each wheel side, to increase the maximum applicable torque. In this case as well, it is preferred if the drives are combined into three or four groups which are controllable by the control means, wherein preferably the drives of each group are controlled equally by the control means.

Anyway, independent of the specific above-mentioned configuration, each mecanum wheel includes multiple, preferably barrel-shaped rolls arranged to be distributed over the circumference, wherein the roll rotational axes of the rolls are arranged at an angle relative to the respective mecanum wheel rotational axis or rim rotational axis of the mecanum wheel. In a manner known per se, the mecanum wheel drives are controllable or are controlled individually or in groups via control means for realizing an omnidirectional operation with which the mecanum wheels or mecanum wheel groups can be rotated with individual speeds and/or rotational directions, wherein the desired or predetermined (overall or resulting) movement direction of the mecanum wheeled vehicle results from a sum of single vectors of the mecanum wheels. In this way, any movement direction, i.e. an omnidirectional operation can be realized despite the omission of a mechanical steering and there is the possibility for rotating or turning the entire mecanum wheeled vehicle on the spot and/or when moving the mecanum wheeled vehicle in a desired movement direction. Insofar, the above-described mecanum wheeled vehicle according to the invention is identical with known mecanum wheeled vehicles. For realizing an increased load capacity or payload option of the mecanum wheeled vehicle, it is now provided that, additionally to the mecanum wheels, support means (not in the form of mecanum wheels) fixed to the chassis or to an in particular height-adjustable carrier element moveably mounted or attached to the chassis, to support a weight proportion, in particular a main weight proportion of a chassis of the mecanum wheeled vehicle and a possible payload on a base (road). At the same time, it is provided within the scope of the invention to limit the proportion of the chassis and of possible superstructural parts and/or of a possible payload which is to be supported on the base via the mecanum wheels to thus prevent an inadmissible overload of the mecanum wheels. To that end, the mecanum wheels are fixed relative to the chassis (in parallel to the weight direction of the vehicle and/or of a payload) in a resilient manner namely using force storage means which are configured and arranged in such a way that only a portion of the weight of an overall weight of the mecanum wheels is to be supported on the base—here, the force storage means have to be configured in a resilient manner for supporting on the base in the vertical direction (i.e. in parallel to the weight direction) and/or perpendicular (at least with a spring force component) to the surface dimension of the chassis or to a support plane defined by the mecanum wheels. Preferably, the force storage means are configured in such a way that the spring travel is limited so that a residual spring travel (in the weight direction) remains or is present in support means supporting on the base. In the case that the support means are also to be mounted resiliently, which is optionally possible, the spring rigidity of the force storage means is to be chosen preferably lower than a spring rigidity of optional support force storage means arranged preferably between the support means and the chassis with which the support means are mounted possibly resiliently relative to the chassis.

As a result, a mecanum wheeled vehicle is obtained, which, upon maintaining the omnidirectional operation mode, enables a corresponding control of the mecanum wheels or the drives thereof and which, at the same, is able to transport a comparatively great payload, since due to a corresponding resilient mounting of the mecanum wheels relative to the chassis and the additional provision of support means, it is ensured that only a weight force proportion of the chassis and/or of a possible payload is supported on the base via the mecanum wheels while the other or respectively remaining weight force proportion, in particular the greatest weight force proportion, can be supported on the base via the support means.

To that end, a support area of the support means and the support area of the mecanum wheels are located together on the base, in particular in a common plane (in case of an ideally planar base).

Here, preferably the spring force or spring rigidity of the force storage means is adapted to the weight of the chassis, of possible super-structural parts and/or to a possible payload in such a way that despite a limit of the weight proportion to be supported via the mecanum wheels, a still sufficient weight force proportion can be or is supported on the base via the mecanum wheels to ensure a (sufficient) traction of the mecanum wheels on the base to ensure an advance for omnidirectionally moving the mecanum wheeled vehicle. In particular, it is to be ensured that the traction is sufficient to transmit a so-called breakaway torque, which is necessary to overcome a resistance, when the vehicle starts to roll, of the vehicle, to the base or that it can be supported on the base.

Here, the mecanum wheel drives, the chassis and the support means form an inseparable unit, which is displaceable as a whole, preferably for the case of not loading a payload in such a way that the support means do not support on the base, as will be described hereinafter within the scope of an advantageous development. Besides a basic suitability of a mecanum wheeled vehicle configured according to the concept of the invention for carrying payloads, it is possible for the first time, due to the invention, to build comparably heavy mecanum wheeled vehicles comprising comparably heavy permanent super-structural parts and to support the weight of these super-structural parts on the base only in part via the mecanum wheels and for the other part via the support means. Particularly preferred is a vehicle type, which can be realized within the scope of the invention in which lifting means are fixed on the chassis with which a payload is height-adjustable relative to the chassis. Such an embodiment enables driving under a payload, to height-adjust the payload relative to the chassis using the lifting means so that a portion of the payload weight is supported on the base via the support means and only a portion of the weight via the mecanum wheels, wherein this weight proportion is selected sufficiently great to ensure a traction of the mecanum wheels on the base.

Regarding the specific configuration of the support means, there are different options. In the simplest case, it is possible to move support means in a dragging manner over the base by driving the mecanum wheels. However, it is particularly preferably if the support means are configured to move together with the chassis in a rolling manner over the base by driving the mecanum wheels for minimizing friction. Here, it is very particularly preferable, if the support means comprise a load wheel rotatable relative to the vehicle around a rotational axis extending preferably in parallel to the base, preferably by 360°, in particular in form of a load roll which, upon a change of direction of the vehicle by a corresponding actuation of the mecanum wheel drives, is rotatable around a steering axis extending preferably perpendicular to the rotational axis of the load wheel with respect to the chassis. For an improved load distribution, it is particularly expedient to provide multiple load wheels configured in such a way and arranged in an articulated manner. It is particularly preferable to provide four load wheels limiting the corners of a rectangle. The at least one load wheel here is preferably configured as a “conventional wheel without additional rolls rotatable relative to the wheel”, i.e. not as a mecanum wheel and preferably not directly but indirectly driven via the mecanum wheels. Preferably, the at least one load wheel is not actively rotatable around the joint axle by means of a steering drive but only passively by a corresponding change of direction of the vehicle, wherein an embodiment with active, i.e. actuated steering can be realized, which directly-driven rotates the load wheel around a joint axle depending on the vehicle direction. Additionally, or as an alternative to a load wheel rotatable around a rotational axis and around a joint axle, it is also conceivable to provide support means in the form of a rotatable roll, in particular arranged in a cage which can roll omnidirectionally and thus can follow a vehicle direction predefined by the mecanum wheels. It is also basically conceivable to provide support means in the type of a tracked vehicle, wherein in this case it is preferred to provide an active steering for pivoting such a chain drive (here, a chain can also be made of a rubber-elastic material) to thus adjust a preference orientation of the chain drive depending on the respective driving direction of the mecanum wheel. Independent of the specific configuration of the support means, these are preferably drivable not actively but indirectly via the mecanum wheel drives.

In particular in a vehicle which is configured for carrying or transporting a payload, it has proven advantageous to configure or provide the force storage means for the mecanum wheels in such a way that the support means, with a chassis not loaded with a payload and which possibly carries super-structural parts, are arranged above a support plane defined by the mecanum wheels and i.e. arranged above the base, and to lower said means not until applying a dimensioned, respectively a heavy payload with simultaneous or automatic increase of the spring tension of the force storage means together with the chassis. In other words, an embodiment is of particular advantage, in which the support means do not contact the base during an empty drive of the mecanum wheeled vehicle but only when applying a corresponding payload which load at the same time ensures that the means with which the mecanum wheels are mounted resilient relative to the chassis are stressed, wherein, as already described, even with support means located in the support plane defined by the mecanum wheels a residual spring travel of the force storage means is to be maintained, in particular to balance unevenness of the base and to prevent that too big a load is to be supported via the mecanum wheels. This is important to ensure for a controlled omnidirectional driving of the mecanum wheeled vehicle even in case of unevenness of the base.

It has proven to be particularly advantageous if the support means are arranged or secured to the chassis height-adjustable and in such a way that a distance between a support area formed by the support means with which the support means are supported on the base for supporting a partial load i.e. a weight force proportion and the base or the support area formed by the support means and thus the distance of the above-mentioned support area toward the chassis is adjustable in order to adjust the spring travel which the force storage means can travel when loading the chassis with a payload until the support area of the support means reaches the base and/or optional support force storage means are tensioned at maximum corresponding to the payload weight. With this measure, the maximum weight to be supported by the mecanum wheels on the base is adjusted. As it will be explained hereinafter, this distance adjustment results preferably depending on a measured weight force of the payload.

As already mentioned at the beginning, an embodiment is realizable in which exclusively the mecanum wheels are mounted resiliently relative to the chassis using the force storage means for limiting the load to be carried or supported at maximum and not the support means. As an alternative, it is conceivable to not only mount the mecanum wheels resiliently relative to the chassis but additionally also the support means via support force storage means, wherein then the spring rigidity of the support force storage means is preferably greater than that of the force storage means to ensure that only a part of the weight is supported or can be supported on the base via the mecanum wheels.

It is particularly appropriate if the force storage means are configured in such a way that even in the case of a mecanum wheeled vehicle applied with a payload, a residual spring travel of the force storage means remains in parallel to the weight direction for granting a residual resiliency. In other words, it is preferred if the spring travel, which theoretically can travel until reaching a stop, in parallel to the weight direction, i.e. the corresponding spring travel component, is longer than the distance of the support area of the support means to the base or to the support plane defined by the mecanum wheels in an unloaded state and/or is longer than a maximum spring travel of optional support force storage means in parallel to the above-mentioned weight direction.

To ensure a sufficient traction of the mecanum wheel drives or the mecanum wheels on the base with different payloads, it has proven advantageous if means for adjusting the prestress of the force storage means and/or a maximum spring travel, which the force storage means can travel upon increase of the spring tension, until the support means contact the base or reach the support plane defined by the mecanum wheels and/or until optional support force storage means are tensioned at maximum corresponding to the payload are adjustable and thus also the weight proportion at maximum to be supported on the base by the mecanum wheels. Here, means drivable manually or preferably using actuator means, in particular an electromotive drive for adjusting the pretension and/or the spring travel can be concerned. The above-mentioned spring travel of the force storage means can, for example, be adjusted by distance variation of a support area of the support means to the base or to the chassis, by a corresponding height-adjustable arrangement of the support means relative to the chassis. In the case of a resilient mounting of the support means relative to the chassis, (manual or actuated) means for adjusting the pretension of the support means on the vehicle can be provided additionally or as an alternative to the above-mentioned means for adjusting the pretension of the force storage means.

It is particularly expedient, as mentioned, if the prestress of the force storage means or of possible support means and/or of a (maximum) spring travel of the force storage means (in particular the distance of a support area of support means to a mecanum wheel support plane or to the base) is adjustable depending on the weight of a payload, wherein it is preferred if the adjustment can be effected in an automated manner, i.e. via actuator means. Now, it has proven to be particularly appropriate if the corresponding weight can be determined using measuring means of the mecanum wheeled vehicle, that is the mecanum wheeled vehicle comprises weight measuring means which are configured and arranged in such a way that the weight of a payload or a weight proportion of this payload, which is supportable on the base via the support means or at least one mecanum wheel, can be measured, wherein these measuring means are connected to the corresponding control means for controlling the above-mentioned actuator means in a signal-conductive manner, wherein the control means vary or adjust the actuator means for adjusting a pre-stressing of the force storage means and/or of the above-mentioned spring travel depending on a sensor signal of the measuring means, i.e. depending on the payload weight (or weight proportion) to limit the stress of the mecanum wheels on the one hand and to grant a sufficient traction, in particular for overcoming a roll-off resistance of the mecanum wheeled vehicle on the other hand.

In the preferred case of the configuration of the mecanum wheeled vehicle as load vehicle which is suitable and appropriate for receiving or for transporting a payload it has proven advantageous if a, in particular tiltable, loading device, preferably a hopper is arranged for receiving the payload.

Additionally or as an alternative, lifting means (distance variation means) for relative height-adjusting (distance-adjusting) of a payload relative to the chassis can be provided on the chassis, wherein in a preferred embodiment of the mecanum wheeled vehicle with support means lifted or spaced apart from the base when not loaded with a payload, the lifting means move the chassis toward the base and thereby tension the force storage means of the mecanum wheels until the support means reach the base and/or optional support force storage means are tensioned. In other words, the lifting means are configured for relative adjusting a lifting or bearing or transport surface relative to the chassis. Preferably, the lifting means comprise a fork, in particular a lifting fork in the type of a fork lift or a lifting platform, wherein the lifting fork or the lifting platform then form or define the above-mentioned bearing or transport surface of the lifting means for receiving a load. Preferably, the bearing or transport surface for loading a payload is oriented or arranged in parallel to the support plane defined by the mecanum wheels.

Regarding the specific configuration of the force storage means for resiliently mounting the mecanum wheels, in particular together with the respective drive (in particular in each case an electro motor), there are different options. In the simplest case, the force storage means (spring means) are configured as classic springs, for example as pressure springs, such as spiral springs and/or torsion springs; the force storage means can also comprise combinations of differently-designed springs. Preferably, such springs are formed from metal and/or formed to be resilient due to the geometry thereof. It is also conceivable that the force storage means include gas pressure springs or hydraulic springs or a combination of mechanical springs, gas pressure springs and/or hydraulic springs. Also, it is conceivable due to the chosen material (e.g. elastomeric material) to exclusively or additionally provide resiliently or energy-storing force storage means. It is essential that the force storage means are configured and arranged in such a way that these ensure, with support means supporting on the base, a limitation of the weight to be supported by the mecanum wheels, i.e. serve for force buffering.

It is very particularly preferably if the mecanum wheels, in particular together with the drives thereof, i.e. the mecanum wheel drives, are arranged on the chassis via resiliently mounted support arms or are mounted resiliently with respect to the chassis, wherein the support arms are pivotably fixed to the chassis in such a way that the spring tension changes by pivoting the support arms. Particularly preferred is an embodiment in which the pivot angle for adjusting the prestress of the force storage means manually or using actuator means to vary the weight or the weight proportion to be supported by the mecanum wheels. It has proven particularly advantageous if the force storage means include torsion springs which can be tensioned by pivoting the support arms.

For granting an optimum base contact and for preventing poises known from prior art, it has proven advantageous if the mecanum wheels, as it is known from WO 2013/041310, comprises two rims which each carry rolls rotatably arranged over the circumference thereof, wherein the rims are connected to one another via damping means which allow for a limited relative movement of the rims, in particular for a relative movement in the circumferential direction and/or perpendicular to a rim rotational axis of the rims and/or at an tilted angle to one another. Preferably, the mecanum wheels are configured as described in the above-mentioned international patent application.

The invention also relates to a system including a mecanum wheeled vehicle configured according to the concept of the invention and a (detachable or removeable) payload carried by said vehicle, wherein a weight of the payload is supported on the base, partially via the mecanum wheels and partially via the support means. Furthermore, the invention also relates to a method for operating a mecanum wheeled vehicle configured according to the concept of the invention. The quintessence of the method is that a portion of the weight of the chassis and/or of a payload of the mecanum wheels and the other portion of the weight is supported on the base via the support means.

Here, it is preferred if the weight, which is supported via the mecanum wheels, is adjusted depending on a measured weight of the payload. In particular by a corresponding adaption of the pretension of the force storage means and/or a spring travel of the force storage means, in particular a maximum spring travel of the force storage means which they have to travel until the support means reach the base and/or until optional support force storage means reach the spring tension maximally caused by the payload.

Further advantages, features and details of the invention result from the below description of preferred exemplary embodiments as well as by means of the drawings.

### BRIEF DESCRIPTION OF THE DRAWINGS

The drawings show in:

FIG. 1a a mecanum wheeled vehicle configured according to the concept of the invention for carrying loads without payload,

FIG. 1b the mecanum wheeled vehicle according to FIG. 1a having a load placed thereon,

FIG. 2 a view on an embodiment designed according to the concept of the invention of a mecanum wheeled vehicle from below;

FIG. 3 an alternative embodiment of a mecanum wheeled vehicle in a side view in a significantly schematized illustration,

FIG. 4 a significantly schematized view of an alternative embodiment of a mecanum wheeled vehicle configured according to the concept of the invention with lifting means arranged on a chassis, here exemplary including a lifting fork, and

FIG. 5 an also significantly schematized alternative embodiment of a mecanum wheeled vehicle.

### DETAILED DESCRIPTION

In the figures, the same elements and elements having the same function are denoted with the same reference characters.

FIGS. 1a and 1b show the basic principle of a mecanum wheeled vehicle 1 configured according to the concept of the invention. This includes a total of four mecanum wheel drives 2 which delimit the edges of an imaginary rectangle and of which only two drives spaced apart in the direction of a longitudinal direction of the vehicle 1 can be seen in the side view. The two further mecanum wheel drives are located behind in the drawing plane. Each mecanum wheel drive 2 includes a mecanum wheel 3 having an electromotive drive (not shown) arranged thereon. All drives are connected in a manner known per se to control means (not illustrated) for individually driving the mecanum wheels 3 to ensure an omnidirectional operation.

It can be seen, that the mecanum wheels 3 are mounted resiliently relative to a chassis 5 via force storage means 4, which chassis carries the mecanum wheels 3 with the drives thereof. The force storage means 4 are merely exemplarily represented as a spiral spring within the scope of a simplified illustration. Other resilient mountings are of course also possible—what is essential is that at least one spring force component oriented perpendicular to a base U acts between the chassis 5 and the mecanum wheels 3.

Besides the mecanum wheels 3, the chassis 5 carries support means 6 fixedly connected thereto, here in the form of load wheels in each case rotatably mounted around a rotational axle 7 as well as around a joint axle 8 oriented perpendicular thereto.

The support means 6 are directly drivable neither around the rotational axle 7 nor around the joint axle 8 using a separate drive but rotate or pivot there-around depending on a movement of the mecanum wheeled vehicle 1 due to the drive of the mecanum wheels 3.

FIG. 1a shows a state without payload. A weight, in the exemplary embodiment essentially caused by the chassis 5, acts on the mecanum wheels 3 via the force storage means 4 so that these support the entire weight on the base in the state shown. The support areas 9 (desired contact area to the base) formed by the support means 6, specifically by the load wheels, are spaced apart from the base U.

FIG. 1b shows the mecanum wheeled vehicle 1 according to FIG. 1A with the payload (load) 10 placed thereon. Said load has a weight F of X Nm. Due to the payload 10 or due to the weight F thereof, the force storage means 4 are stressed by traveling a spring travel in which the chassis 5 with payload 10 automatically adjusts downward against the spring force of the force storage means 4 in the weight direction until the support means 6 support on the base with the support area 9 thereof. A marginal residual spring travel of the force storage means remains for balancing unevenness of the base U (residual resilience). By a corresponding selection of the force storage means 4 and the remaining residual spring travel or the residual resilience, the weight to be supported by the mecanum wheels 3 is limited. In other words, only a portion of the weight of the payload 10 is supported on the base via the mecanum wheels 3 and the other portion via the support means. The force storage means 4 are selected such that sufficient traction of the mecanum wheels 3 is provided based on the payload 10 or the corresponding total weight to move the mecanum wheeled vehicle (omnidirectionally).

An embodiment is particularly preferably in which the pre-stressing of the force storage means 4 is adjustable, in particular depending on the payload 10 to be loaded and/or a pretension of optional support force storage means not shown with which the support means 6 can be mounted resiliently relative to the chassis 5 if necessary. It is also conceivable to adjust the distance of the support area based on the state according to FIG. 1a without a load relative to the base for adjusting the spring travel and therefore of a residual spring travel of the spring.

Very particularly preferably, at least one of the above-mentioned adjustments is effected depending on the weight to be determined or a weight proportion of the payload 10 to be determined. To that end, for example measuring means 11 (force measuring means) can be provided as indicated in FIG. 1, for example on the chassis 5, with which the weight of a payload can be determined. Depending on the weight which can alternatively also be determined from outside the mecanum wheeled vehicle 1, one of the above-mentioned adjustments is effected manually or via actuator means, wherein it is very particularly preferably if this is effected automatically depending on a sensor signal of the measuring means 11 by corresponding controls of the actuator means using the control means.

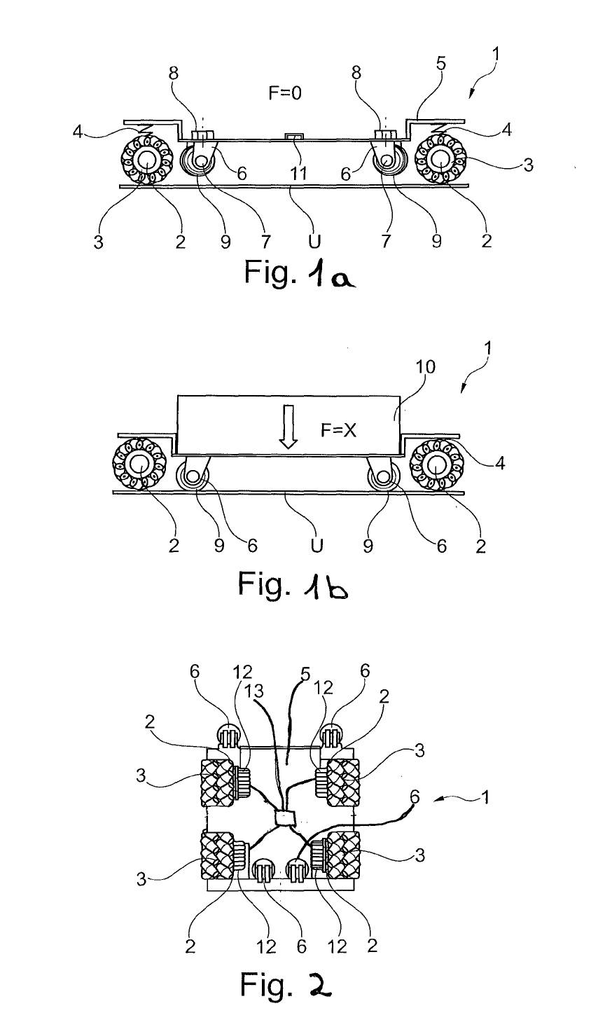

FIG. 2 shows a possible embodiment of a mecanum wheeled vehicle 1 which is configured according to the concept of the invention from below. The four mecanum wheel drives 2 limiting the edges of a virtual rectangle can be discerned, which in each case include a mecanum wheel 3 which is drivable using a drive, here in each case an electromotive drive 12 for ensuring omnidirectional operation. Here, the drives 12 are driven in a distinct direction and/or with a distinct speed by control means 13.

Each mecanum wheel includes a multitude of rolls, preferably barrel-shaped rolls arranged distributed over the circumference of the wheel, the roll rotational axes thereof are arranged at an angle relative to the mecanum wheel rotational axes, wherein preferably the mecanum wheel rotational axes of two neighboring mecanum wheels align and the mecanum wheel rotational axes of two pairs of mecanum wheels are aligned in parallel to one another.

The chassis 5 can be discerned, relative to which the mecanum wheel drives 2 are mounted resiliently. The chassis 5 additionally carries support means 6 for carrying a load.

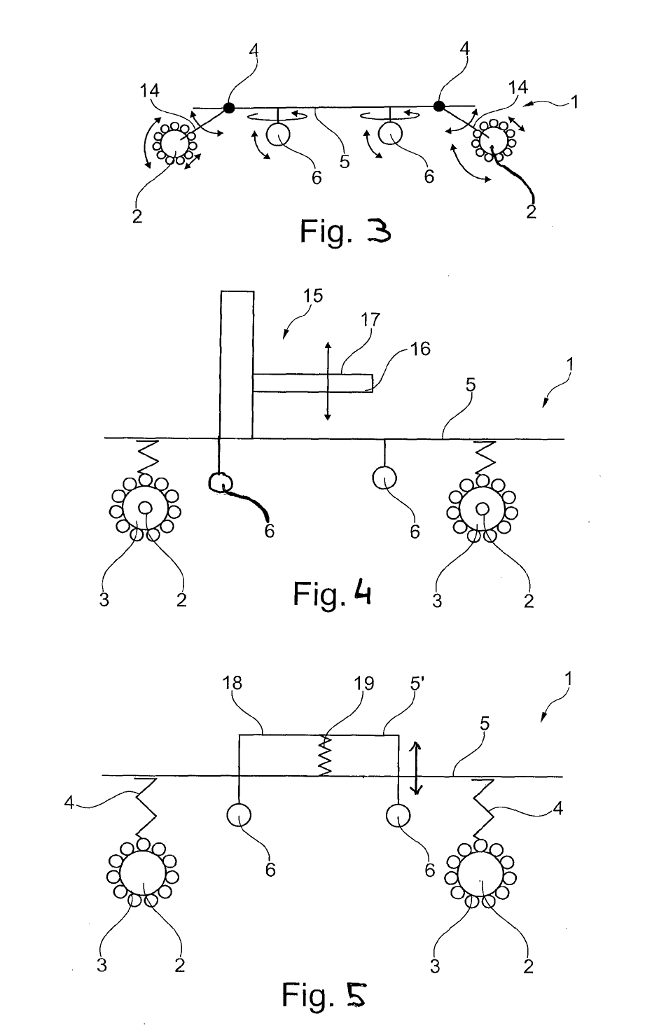

FIG. 3 shows a preferred embodiment of a mecanum wheeled vehicle 1 in a significantly schematized manner. The mecanum wheel drives 2 are pivotably hinged on the chassis 5 via support arms 14. Force storage means 4 in the form of torsion springs are assigned to the support arm 14, wherein the torsion springs can be tensioned preferably with separate drives not shown for varying the pretension of the force storage means. Of course, differently designed springs, e.g. gas pressure springs or spiral springs can be used additionally or as an alternative to torsion springs.

It can be discerned here as well, that support means 6 are provided next to the mecanum wheels 3, with which a part of a payload to be carried can be supported on a base.

FIG. 4 shows a mecanum wheeled vehicle 1 in a significantly schematized view which in terms of the basic structure thereof corresponds to the exemplary embodiment according to FIG. 1a to 2. Lifting means 15 (distance variation means) are located on the chassis 5 for changing a distance between a bearing surface 17 defined by the lifting means 15 for a load to be transported and the chassis 5. In the specific exemplary embodiment, the lifting means 15 include a lifting fork 16 which is arranged height-adjustable relative to the chassis 5 with a suitable, for example electromotive drive.

Alternative lifting means 15, for example in the form of a piston cylinder arrangement, a spindle drive or a scissor joint drive or the like drives of height-adjustable platforms are realizable. Preferably, the drives include a motor, in particular an electric motor.

FIG. 5 shows an alternative embodiment of a mecanum wheeled vehicle 1 with mecanum wheel drives 2 and support means 6 which are lifted from the base in analogy to the exemplary embodiment according to FIGS. 1a and 1b when applied with a payload. The support means 6 include rolls arranged rotatable and steerable which are installed at a height-adjustable chassis portion of the chassis 5 which is referred to as carrier element 18 in the exemplary embodiment shown which in turn is installed height-adjustable on the chassis 5. In other words, the support means 6 are fixed height-adjustable on the chassis 5. The carrier element 18 supports on the chassis 5 via a spring element 19 and serves for receiving a payload. Here, the spring rigidity of the spring element 19 is lower than the spring rigidity of the force storage means 4 whereby the carrier element 18 lowers when loading with a load until the support means 6 or the support area thereof reaches the base, wherein, in this state, a residual spring travel of the force storage means 4 is ensured so that only a proportional weight force is supported on the base via the mecanum wheels 3.

### LIST OF REFERENCE CHARACTERS

1 mecanum wheeled vehicle
2 mecanum wheel drive
3 mecanum wheels
4 Force storage means
5 Chassis
6 Support means
7 Rotational axis ZDR-P-
8 Joint axis
9 Support area
10 Payload
11 Measuring means
12 Drives of the mecanum wheel drives
13 Control means
14 Support arms
15 Lifting means
16 Lifting fork
17 Bearing surface
18 Carrier element
19 Spring element
20 U Base

1. Mecanum wheeled vehicle for transporting a payload,
having multiple mecanum wheel drives (2), in each case including at least one mecanum wheel and at least one electromotive drive,
having control means (13) configured for controlling the mecanum wheel drives (2) for an omnidirectional operation,
having a chassis (6), the weight force of which can be supported on a base (U) via the mecanum wheels (3) as well as via support means (6) of the vehicle provided additionally to the mecanum wheels (3),
wherein the mecanum wheels (3), together with the assigned drives, are mounted resiliently relative to the chassis using force storage means (4) for limiting the weight force proportion of the chassis (5) to be supported via the mecanum wheels (3) on the base (U) and a possible payload (10) to be carried by the chassis.

2. Vehicle according to claim 1, wherein the support means (6) comprise at least one load wheel rotatable around a rotational axis (7) when driving the vehicle, which is rotatable around a joint axis upon a change of direction of the vehicle and/or wherein the support means (6) comprise a rotatably arranged ball for supporting on the base (U).

3. Vehicle according to claim 1, wherein the force storage means (4) are configured and arranged in such a way that when the chassis (5) is not loaded with a payload (10), the support means (6) are arranged above a support plane defined by the mecanum wheels (3) and when being applied with a payload (10), lower toward the base (U) with simultaneous increase of the spring tension of the force storage means (4), in particular together with the chassis (5).

4. Vehicle according to claim 3, wherein the distance between a support area (6) formed by the support means (6) and the support plane defined by the mecanum wheels (3) is adjustable.

5. Vehicle according to claim 3, wherein when loaded with a payload (10), a maximum spring travel component of the force storage means (4) parallel to an adjustment direction of the chassis (5) without payload (10) is greater than the distance measured in the same direction between a support area of the support means (6) and the support plane defined by the mecanum wheels (3).

6. Vehicle according to claim 1, wherein the support means (6) are not mounted resiliently relative to the chassis (5), or are mounted resiliently relative to the chassis (5) in such a way that a spring rigidity of the support force storage means is greater than a spring rigidity of the force storage means (4).

7. Vehicle according to claim 1, wherein a prestress of the force storage means (4) and/or a spring travel of the force storage means for adjusting the maximum weight proportion to be supported on the base by the mecanum wheels (3) is adjustable manually or by means of actuator means.

8. Vehicle according to claim 1, wherein the mecanum wheeled vehicle (1) comprises measuring means (11) for determining a weight force or a weight force proportion of the chassis (5) and/or of a payload (10), and wherein the measuring means (11) are connected, in a signal-conductive manner, to control means (13) for actuating actuator means for adjusting the prestress of the force storage means (4) and/or the spring travel depending on the sensor signal of the measuring means (11).

9. Vehicle according to claim 1, wherein a loading device is arranged on the chassis (5) for receiving a payload (10).

10. Vehicle according to claim 1, wherein a lifting means (15) for lifting a payload (10) relative to the chassis (5) are arranged on the chassis (5).

11. Vehicle according to claim 1, wherein the mecanum wheels (3) together with the drives are arranged on the chassis (5) via pivotable support arms (14) mounted resiliently by means of torsion springs, in such a way that the spring tension of the force storage means (4) changes by pivoting the support arms (14) and/or wherein the spring prestress of the force storage means (4) is adjustable by actively adjusting the pivoting angle of the support arms (14) manually or by using actuator means.

12. Vehicle according to claim 1, wherein the mecanum wheels (3) comprise multiple rims having in each case rotatably mounted rolls arranged in a manner to be distributed over the circumference thereof relative to the respective rim and wherein two neighboring ones of the rims are connected to one another via damping means which are configured to allow for an dampened, limited relative movement of the rims in the circumferential direction and/or perpendicular to a mecanum wheel rotational axis and/or perpendicular to a rim rotational axis of the rims and/or in manner as to allow for a tilted angle to one another.

13. System including a mecanum wheeled vehicle (1) according to claim 1, and a payload (10) carried by said vehicle, wherein a weight force of the payload (10) is supported on a base (U) proportionately via the mecanum wheels (3) and proportionately via the support means (6).

14. System according to claim 13, wherein when applied with a payload (10), the force storage means (4) can be compressed by a remaining spring travel for balancing an unevenness of the base (U).

15. Method for operating a mecanum wheeled vehicle according to claim 1, wherein one part of the weight force of the chassis (5) and/or of a possible payload (10) is supported on the base (U) via the mecanum wheels (3) and the other part of the weight force via the support means (6).

16. Method according to claim 15, wherein the weight force of a payload (10) is measured, and wherein a prestress of the force storage means (4) and/or a spring travel of the force storage means (4) is/are adjusted depending on the measured weight force.

17. Vehicle according to claim 1, wherein the multiple mecanum wheel drives (2) comprises three or four mecanum wheel drives.

18. Vehicle according to claim 9, wherein the loading device is a hopper.

19. Vehicle according to claim 10, wherein the lifting means (15) are drivable by means of an actuator and include a piston cylinder drive and/or a scissor joint drive having a lifting fork (16) or a lifting platform.

20. Method according to claim 16, wherein the weight force of the payload (10) is measured on the mecanum wheeled vehicle (1).
